(19) United States
(12) Patent Application Publication
(10) Pub. No.: US 2012/0138207 A1
(43) Pub. Date: Jun. 7, 2012

(54) METHOD AND DEVICE FOR SMOOTHING A SURFACE OF A COMPONENT, PARTICULARLY OF LARGE STRUCTURES

(76) Inventors: Konrad Ortlieb, Stuttgart (DE); Frank Herre, Oberriexingen (DE); Hans-Georg Fritz, Ostfildern (DE); Timo Beyl, Besigheim (DE); Marcus Kleiner, Ingersheim (DE)

(21) Appl. No.: 13/389,844

(22) PCT Filed: Aug. 9, 2010
(86) PCT No.: PCT/EP2010/004856

§ 371 Date: Feb. 10, 2012

(30) Foreign Application Priority Data
Aug. 10, 2009 (DE) 10 2009 036 838.8

(51) Int. Cl. B05D 5/00; B05D 3/02; B24B 1/00; B05C 11/00; B05C 5/00; B32B 37/02; B05D 3/06; B05D 3/12

(52) U.S. Cl. 156/64; 427/8; 118/712; 451/28

(57) ABSTRACT

A method and apparatus for smoothing a surface of a component, e.g., of large structures, as for example ship hulls for subsequent painting, is disclosed. An exemplary method may include measuring an unevennesses of the surface of the component, levelling the unevennesses by material removal and/or by material application of a levelling mass, adding reference markings at certain locations on the surface to be measured before the measurement of the surface, and taking account of the reference markings during the measurement of the unevennesses of the surface.

### CROSS-REFERENCES TO RELATED APPLICATIONS

This application is a National Stage application which claims the benefit of International Application No. PCT/EP2010/004856 filed Aug. 9, 2010, which claims priority based on German Application No. DE 10 2009 036 838.8, filed Aug. 10, 2009, both of which are hereby incorporated by reference in their entireties.

### FIELD

The present disclosure relates to a method for smoothing a surface of a component, e.g., of large structures, such as for example the hulls of ships and superstructures of ships. Furthermore, the present disclosure is directed to a device which is suitable for carrying out this method.

### BACKGROUND

When producing yachts (e.g. sailing yachts, motor yachts) in the luxury sector, the highest demands are placed on surface quality of the painting of the hull and all superstructures, which demands are generally substantially stricter than in the case of other ships, such as for example cargo ships or warships. This is particularly problematic in the case of large yachts, for which the hull is typically welded together from steel and aluminum parts, as the hull surface then has to be processed and coated in an expensive manner. Conventionally, in this case, initially base material treatment takes place using the methods conventional in metal processing, such as for example deposition welding, shrink welding, grinding and sandblasting. Subsequently, a primer (“Haftgrundierung”) is then applied. In a next step, a filler is then applied or sprayed on, in order to level coarse surface unevennesses. Subsequently, a putty or filler is then applied, which is to some extent also designated as primer and has the task of levelling fine surface unevennesses. In a further step, a glossy intermediate paint is then applied, followed by a colour- and effect-imparting base paint or a top paint. In a final step, a clear paint is generally then applied, this step merely being optional in the case of a top paint.

The previously mentioned work steps for levelling the surface unevennesses are conventionally carried out manually, which results inconsiderable work and time outlay. Furthermore, the manual processing of the hull of the ship contains numerous sources for defects. For example, filler can be used which is already cured to some extent and is therefore not or is only partially suitable for processing. Furthermore, there is the possibility that the filler has been applied too thickly. Further, the levelling of the unevennesses here takes place by eye which can lead to corresponding unevennesses. A further disadvantage for the manual levelling of surface unevennesses consists in the relatively high consumption of filler. Finally, for the manual application of the filler, relatively long drying times are required, as otherwise the filler would cure already during processing, so that only a processing time which is too short would be available.

DE 10 2006 036 345 B4 discloses a method for treating at least one object present in a delimited region in an arrangement, the shape of which can be described by one or a plurality of elements which have a relationship to one another and respectively have at least one regular geometric element. U.S. 2003/0139836 A1 discloses a method for inspecting painted surfaces, locating and tracking defects in the painted surface and repairing such paint defects.

An automated method for levelling the surface unevennesses of a hull of a ship is furthermore known from EP 1 103 310 B1. Here, the hull of a ship to be painted is measured in a dry dock by a plurality of robots, in order to detect the surface unevennesses. Subsequently, a filler is then applied onto the surface of the hull, in order to level the surface unevennesses. In a further step, the hull of the ship is smoothed with the filler located thereon and cured, in order to achieve the desired surface quality for the subsequent painting process.

Disadvantageous for this automated method for levelling the surface unevennesses of the hull of the ship is initially the fact that, following the application of the filler, large quantities of the applied filler are milled off or grinded off again.

This disadvantage is based on the fact that the measurement of the surface of the hull of the ship can only take place in this known automated method with relatively low precision.

Accordingly, there is a need for an improved method, e.g., an automated method, for leveling unevennesses of the surface of a hull of a ship.

### BRIEF DESCRIPTION OF THE FIGURES

While the claims are not limited to the specific illustrations described herein, an appreciation of various aspects is best gained through a discussion of various examples thereof. Referring now to the drawings, illustrative examples are shown in detail. Although the drawings represent the exemplary illustrations, the drawings are not necessarily to scale and certain features may be exaggerated to better illustrate and explain an innovative aspect of an illustration. Further, the exemplary illustrations described herein are not intended to be exhaustive or otherwise limiting or restricting to the precise form and configuration shown in the drawings and disclosed in the following detailed description. Exemplary illustrations are described in detail by referring to the drawings as follows:

FIG. 1 shows an exemplary device for carrying out an exemplary method for surface processing of a hull of a ship, e.g., a yacht; and

FIGS. 2A and 2B show an exemplary method in the form of a flow diagram.

### DETAILED DESCRIPTION

Various exemplary illustrations are provided herein of a method and apparatus, e.g., for smoothing a surface of a component for subsequent painting. An exemplary method may include measuring an unevennesses of a surface of the component, levelling the unevennesses by at least one of material removal and material application of a levelling mass, adding a plurality of reference markings at certain locations of the component to be measured before the measurement of the surface, and taking account of the reference markings during the measurement of the unevennesses of the surface.

The exemplary illustrations include a technical insight that it is not sufficient for determining the surface unevennesses of the hull of the ship to create a three-dimensional image of the hull of the ship. Rather, it is also advantageous to assign a three-dimensional image of a surface section of the hull of the ship to the associated real surface section of the hull of the ship as precisely as possible. Problematic in the case of the previously mentioned automated measuring method is namely the fact that the measurement and the subsequent surface processing take place temporally successively. In the case of surface processing, it must therefore be ensured that the previously taken three-dimensional image of the respective surface section is assigned to the associated real surface section of the hull of the ship as precisely as possible. This requires very great precision, however, in the positioning of the robot which is initially used for measurement and subsequently for processing the surface of the hull of the ship.

The exemplary illustrations_therefore generally provide that reference markings are attached at certain locations on the surface of the hull of the ship, in order to facilitate the measurement of the surface unevennesses. The reference markings are then taken into account in the context of the exemplary illustrations in the measurement of the unevennesses of the surface and, for example, also in the subsequent processing of the surface. In one exemplary illustration, accordingly, the measurement of a surface unevenness may be based at least in part upon the position of one or more reference markings, e.g., in relation to the measured surface. The reference markings here enable a clear and exact assignment of the three-dimensional image of the respective surface section taken to the real surface section of the hull of the ship. When positioning robots for measuring and for subsequent processing of the surface, only a relatively low positioning precision is required, as the possibility of a spatial orientation exists at the reference markings.

In one exemplary illustration, computer-aided design data of the component to be processed (e.g. a hull of a yacht) are provided, e.g., as may be provided using a conventional CAD design systems (CAD: Computer Aided Design). From these computer-aided design data, a virtual surface contour of the component may then be created, e.g., an idealised surface contour which does not have any surface unevennesses caused by production and tolerances. Furthermore, the real surface contour of the component may then be measured, to which end a rotary laser can be used for example. Further, in one exemplary illustration, the spatial position of the individual reference markings on the surface of the component are measured, in order to achieve a precise assignment between the virtual (planned) surface contour and the real surface contour. The real surface contour may then be compared with the virtual surface contour, in order to determine the unevennesses from the difference between the real surface contour and the virtual surface contour which must then be levelled.

In this levelling, various surface unevennesses can be levelled, namely on the one hand negative deviations (dents) and on the other hand positive deviations (raised locations). In order to be able to level the latter, a new surface line maybe defined. This may be performed by a person, if appropriate with support from (a) software tool(s). The technical term for this is “straken”.

It has already been mentioned previously that the measurement of the surface of the component can for example take place by means of a rotary laser. Any rotary laser may be employed that is convenient. Alternatively, however, there is also the possibility that the surface of the component is measured with other methods which have sufficient precision. Merely as examples, a radar measurement may be obtained, e.g., as mentioned briefly in EP 1 103 310 B1 and corresponding U.S. Pat. Pub. No. 2002/0064596, and ultrasound measurements may also be employed.

According to the exemplary illustrations, the difference between the real and the virtual (planned) surface may advantageously not be filled over a large area in coarse steps, but rather in many thin layers or very many small droplets, it being possible for the latter also to be designated as digital application, as the coating is varied in that droplets of a certain size are applied or not, whereas the droplet size itself remains unaffected. In this case, classic spray applicators or special applicators designed for highly-viscous materials or also correspondingly modified print heads (e.g. inkjet) can be used. For material application during levelling the surface unevennesses, a plurality of layers of a levelling mass (e.g. filler) can therefore be applied onto the surface of the component in the context of the exemplary illustrations. Alternatively, in the context of the exemplary illustrations, there is the possibility that for material application during the levelling the surface unevennesses, numerous droplets of the levelling mass are applied onto the surface of the component.

The thickness of the individual layers which are applied onto the surface of the component can for example lie in the range from 50 μm-100 μm, 100 μm-1000 μm or in the range from 1 mm-5 mm. The exemplary illustrations are not limited to the specific value ranges mentioned previously by way of example with respect to the layer thickness, but rather can also be realised with other layer thicknesses.

In one exemplary illustration, the material removal or material application for levelling the surface unevennesses takes place by means of a multi-axial robot which guides a tool for material removal and/or an application device for material application. Any robot may be employed that is convenient, e.g., a robot from painting installations for painting motor vehicle body components, and can be used in a slightly modified form also for painting yachts.

An exemplary robot can here be moved along the surface of the component, e.g., along a displacement axis, in order to process a plurality of surface sections one after the other. In the method of the robot, the robot can orientate on the basis of the reference markings. To this end, the robot can, merely as an example, move to the individual reference markings by means of a measuring tip attached to the robot, in order thereby to determine its position. Alternatively, there is also the possibility that the robot determines the position of the reference markings by means of an optical image processing, or in any other manner that is convenient.

With respect to the levelling mass which is used for levelling the surface unevennesses, there are many possibilities, of which some are described briefly in the following. For example, the levelling mass can be a single component material or a two-component material. Furthermore, there is the possibility that the levelling mass is air-, heat-, radiation-curable and/or chemically independently curable. Furthermore, the levelling mass can consist at least partially of a thermoplastic plastic. Moreover, there is also the possibility that the levelling mass consists at least partially of a metal which is applied in liquid form.

In the case of the use of radiation-curable levelling mass, the levelling mass for curing can for example be irradiated with ultra-violet radiation (UV radiation), high-frequency radiation, particularly microwave radiation, heat radiation or infra-red radiation, in order to cure the levelling mass on the component surface.

The levelling mass may be sprayed on, which facilitates an automated method, and further may thereby not need to be spackled onto the surface of the component.

The previously mentioned robot may, for example, not only used for measuring the surface of the component, but rather also for spraying on the levelling mass.

Also, with respect to the previously mentioned reference markings, there are many possibilities, of which some are described briefly in the following. For example, the reference markings can be embossed or sprayed on and there is alternatively the possibility that material is removed in a locally delimited manner for adding the reference markings. Further, there is also the possibility that the reference markings are simply stuck on.

In one exemplary method, mirror spheres are screwed in threaded sleeves present on the ship and added extra for this. These mirror spheres are welded on at locations which are not processed, but rather are covered later by boarding (e.g., drop ceilings). The rotary laser in this case may be located outside the ship (e.g. on a scaffold). Alternatively, there is also the possibility that the rotary laser is located on a deck of the ship, in order to facilitate the taking of a more detailed image. The step with the robot may first be used when the ship is completely measured, straked and filler application is calculated. Then, the measurement by a measuring system attached on the robot or on its supporting framework serves the purpose that the robot knows where it is located and at which location it is to apply which quantity of filler (and respectively in a second step, how much it must mill off and grind off).

Furthermore, a thin wire can be used for later positioning of the robot, which wire may be attached before spackling on the sheet or in the filler (after a first application). The robot can then sense the wire by means of a sensor and determine its position as a result.

Further, for positioning the robot, there is the option that a mechanical scanner scans the edge, in order to find the end of the last application or the end of the last processing (e.g. by milling) precisely enough. Area calculation in the space then takes place by means of a plurality of points.

In the case of spray filler with sharp edges, the measurement method by means of scanners may be more effective, in the case of thin applications and unsharp layer thickness transition (Gaussian curve), this may be more difficult.

This type of location determination maybe advantageous in particular in the case of grinding and milling.

Further, it is to be mentioned that the exemplary illustrations are not limited to the previously mentioned method for levelling the surface unevennesses. Rather, the exemplary illustrations also comprise the further step of painting the component surface which can likewise take place by means of the robot. The robots used in the context of the exemplary illustrations can therefore also fulfill a plurality of functions, namely the measurement of the surface unevennesses of the component, the application (e.g. spraying on) of the levelling mass and finally also the painting of the surface.

within contrast to the conventional automated method mentioned above, the exemplary methods make it possible that no further processing steps take place between the levelling of the unevennesses by the application of the levelling mass and the subsequent painting. Thus, in the case of the exemplary methods, it is not absolutely necessary that the surface is post-processed between these processing steps, for example by means of grinding or even milling of the surface.

However, there is also the possibility in the context of the exemplary illustrations that between the levelling the unevennesses by means of the application of the levelling mass and the subsequent painting, a further processing step is carried out, such as for example the grinding of the surface and/or the irradiation of the surface with a surface processing laser for finer material removal in order to achieve an even higher surface quality.

In the case of the previous description of the exemplary methods, it was assumed that the component to be processed is a ship, particularly a sailing yacht or a motor yacht. The exemplary method scan also be applied in the same manner with other components, such as for example in the case of rotor blades of wind power installations, aeroplane components (e.g. aeroplane fuselages, aeroplane wings), as well as in the case of vehicles, e.g., in the case of railway carriages or railway motor units.

Finally, the exemplary illustrations also comprise a device which is suitable for carrying out the exemplary methods.

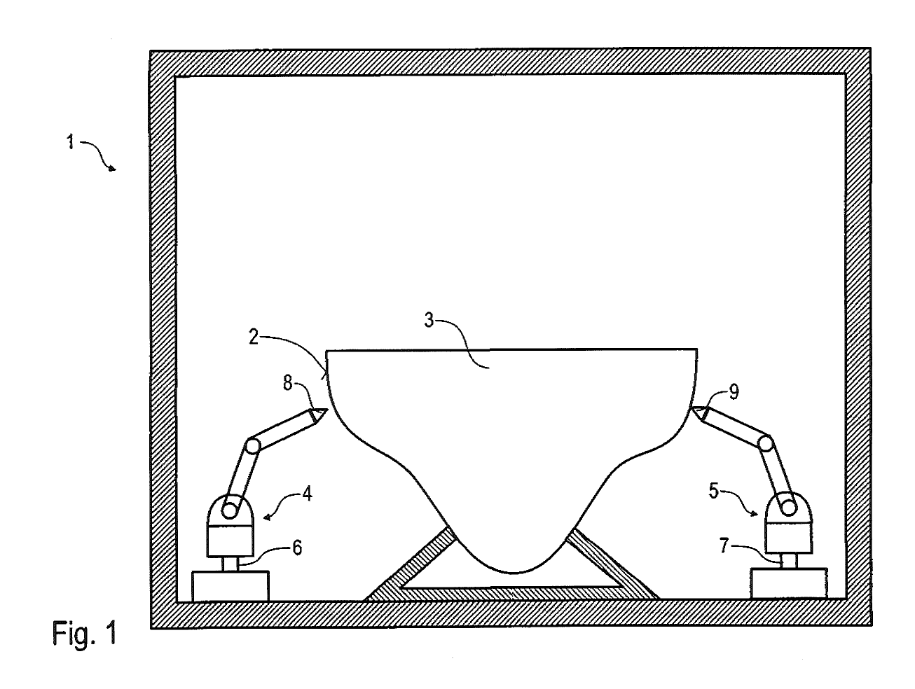

FIG. 1 shows a device 1 for processing the surface 2 of a hull 3 of a ship in greatly simplified form, it being possible for it to be a luxury yacht for example, in the case of which the surface quality of the surface 2 must satisfy the highest demands.

The device 1 therefore has robots 4, 5 on both sides of the hull 3 of the ship, which robots can be displaced along a travel rail 6 and 7, respectively along the hull 3 of the ship, in order to process the entire surface 2 of the hull 3 of the ship over the entire length. It is to be mentioned here that a type of Z axis can be provided in order to regulate the spacing of the applicator or the entire robot from the surface.

The robots 4, 5 have a plurality of functions in the context of the exemplary methods, which are explained briefly in the following.

On the one hand, the robots 4, 5 can measure the real surface contour of the surface 2 of the hull 3 of the ship, in order to detect unevennesses of the surface 2, which impair the surface quality of the later painting. To this end, the robots 4, 5 can guide suitable instruments, such as for example rotary lasers, radar devices or ultrasound distance meters.

On the other hand, the robots 4, 5 should apply a levelling mass onto the surface 2 of the hull 3 of the ship, in order to level the previously detected surface unevennesses and to achieve a surface quality which is as smooth as possible. To this end, the robots 4, 5 each have an applicator 8 and 9, respectively which is able to apply the levelling mass onto the surface 2 of the hull 3 of the ship.

Finally, the robots 4, 5 may also have the task of painting the surface 2 of the hull 3 of the ship.

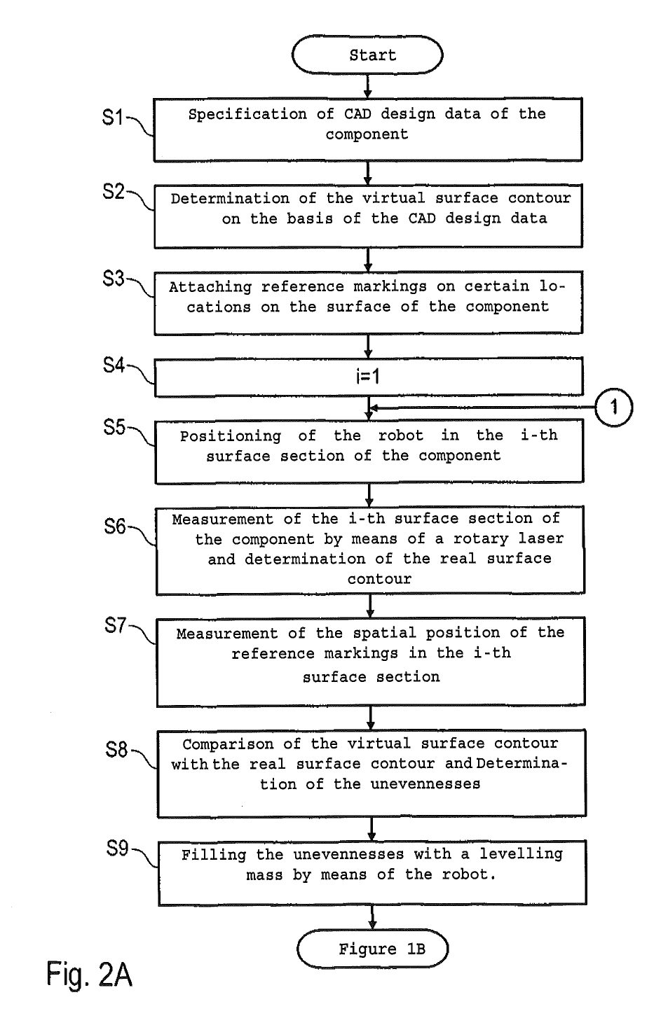

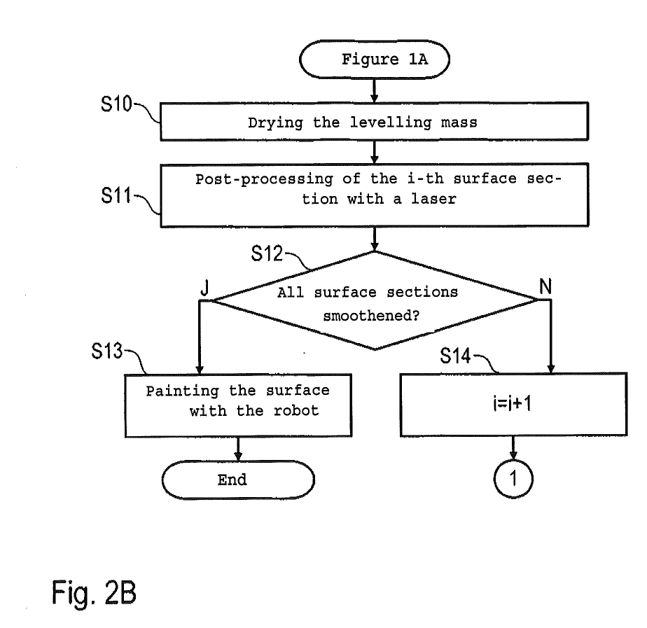

In the following, an exemplary method is are described with reference to the flow diagram which is illustrated in the FIGS. 2A and 2B.

In a first step S1, initially CAD design data of the hull 3 of the ship may be provided. The CAD design data may generally be present anyway in a computer-aided CAD design system and therefore do not have to be generated separately.

Subsequently, the virtual (planned) surface contour of the surface 2 of the hull 3 of the ship may then be determined on the basis of the CAD design data in a further step S2. This virtual surface contour may bean idealized surface contour which does not take account of the surface unevennesses of the surface 2 caused by the production and tolerances.

In a step S3, reference markings may then be added at certain locations on the surface 2 of the hull 3 of the ship. These reference markings should make it possible later to assign a virtual surface section exactly to a real surface section.

In the next step S4, initially a first surface section to be measured may be initialized in that a counter i=1 is set.

Thereupon, the robots 4 and 5, respectively may then be positioned in a next step S5 in the i-th surface section of the surface 2 of the hull 3 of the ship. This positioning of the robots 4, 5 for the following surface measurement may however be generally only necessary if the surface measurement takes place by means of a rotary laser mounted on the robots 4, 5. In the case of a stationary rotary laser, this step may not be necessary, by contrast.

After this positioning, the i-th surface section of the hull 3 of the ship may then be measured in the step S6, which for example can take place by means of a rotary laser. In this case, the real surface contour of this surface section, which also takes account of surface unevennesses caused by production and tolerances, is also determined.

In a next step S7, the spatial position of the reference markings applied onto the surface 2 of the hull 3 of the ship within the i-th surface section may then be measured, and the measurement of the surface contour and the measurement of the position of the reference markings may take place at the same time.

Proceeding to step S8, a comparison of the virtual (planned) surface contour with the real (measured) surface contour may then take place, the unevennesses/deviations of the surface being determined from the difference between the virtual surface contour and the real surface contour.

Then, the creation of the new surface line takes place, which is also designated as “Straken” in the specialized terminology.

In the step S9, the new surface 2 of the hull 3 of the ship may be modelled, to which end the robots 4 and 5, respectively apply a levelling mass onto the surface 2 of the hull 3 of the ship.

After the application of the levelling mass onto the surface 2 of the hull 3 of the ship, the levelling mass may then initially dry and cure in the step S10.

Proceeding to step S11, a post-processing of the i-th surface section can then take place using a laser, in order to further improve the surface quality. Instead of a post-processing of the surface by means of a laser, there is also the possibility that the surface is post processed by milling and/or grinding.

In the step S12, a check may then be made as to whether all surface sections of the surface 2 of the hull 3 of the ship have been smoothed.

In the event that this is the case, it is possible to transition to step S13, in which the surface 2 of the hull 3 of the ship is painted by the robots 4, 5, which can take place in the conventional manner.

In the case by contrast that the check in step S12 produces the result that not yet all surface sections have been smoothed, then the counter i may be incremented in the method step S14, whereupon a transition to step S5 is made in a loop, until all surface sections of the surface 2 of the hull 3 of the ship have been smoothed in the context of the loop.

The exemplary illustrations are not limited to the previously described examples. Rather, a plurality of variants and modifications are possible, which also make use of the ideas of the exemplary illustrations and therefore fall within the protective scope. Furthermore the exemplary illustrations also include other useful features, e.g., as described in the subject-matter of the dependent claims independently of the features of the other claims.

Reference in the specification to “one example,” “an example,” “one embodiment,” or “an embodiment” means that a particular feature, structure, or characteristic described in connection with the example is included in at least one example. The phrase “in one example” in various places in the specification does not necessarily refer to the same example each time it appears.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be evident upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary is made herein. In particular, use of the singular articles such as “a,” “the,” “the,” etc. should be read to recite one or more of the indicated elements unless a claim recites an explicit limitation to the contrary.

1. A method for smoothing a surface of a component for subsequent painting, comprising:
measuring an unevennesses of the surface of the component,
levelling the unevennesses by at least one of material removal and material application of a levelling mass,
adding a plurality of reference markings at certain locations of the component to be measured before the measurement of the surface, and
taking account of the reference markings during the measurement of the unevennesses of the surface.

2.-16. (canceled)

17. The method according to claim 1, further comprising at least one of the following additional steps for measuring the unevennesses of the surface:
providing a spatial position of each of the reference markings,
measuring a real surface contour of the component,
measuring the spatial position of each of the reference markings,
assigning the real surface contour to the virtual surface contour on the basis of at least the spatial position of at least one of the reference markings,
comparing the real surface contour with the virtual surface contour,
determining a deviation from the comparison, and
creating a new ideal surface contour.

18. The method according to claim 17, wherein the spatial positions of the reference markings are provided in the form of computer-aided design data of the component including the spatial positions of the reference markings.

19. The method according to claim 18, further comprising determining a virtual surface contour of the component on the basis of the design data.

20. The method according to claim 1, wherein the measurement of the surface of the component takes place by means of a rotary laser.

21. The method according to claim 1, wherein levelling the unevennesses includes material application of a levelling mass, wherein a plurality of layers of a levelling mass are applied onto the surface of the component.

22. The method according to claim 1, wherein levelling the unevennesses includes material application of a levelling mass, wherein a plurality of droplets of a levelling mass are applied onto the surface of the component.

23. The method according to claim 21, wherein the individual layers each have a layer thickness which lies in one of the following ranges:
50 μm-100 μm;
100 μm-1000 μm; and
1 mm-5 mm.

24. The method according to claim 1, wherein at least one of the material removal and the material application takes place by means of a multi-axial robot which guides at least one of a tool for material removal and an application device for material application.

25. The method according to claim 24, wherein the robot is moved along the surface, in order to process a plurality of surface sections one after the other.

26. The method according to claim 24, wherein the robot orientates on the basis of the reference markings during movement.

27. The method according to claim 24, wherein the robot scans the reference markings with a measuring tip guided by the robot and thereby determines the spatial position of the reference markings.

28. The method according to claim 24, wherein the spatial position of the reference markings is determined by an image processing system.

29. The method according to claim 1, wherein the leveling mass includes at least one of the following:
a plurality of different materials,
an air-curable material,
a heat-curable material,
a radiation-curable material,
a chemically independently curable material,
a thermoplastic plastic,
a metal applied in a liquid form.

30. The method according to claim 29, wherein the levelling mass includes a radiation-curable material, the radiation-curable material configured to be irradiated with one of the following radiations for curing:
ultra-violet radiation,
microwave radiation,
heat radiation, and
long wave infra-red radiation.

31. The method according to claim 1, wherein the levelling mass is sprayed onto the surface of the component.

32. The method according to claim 31, wherein the leveling mass is sprayed onto the surface of the component with an applicator attached to a robot.

33. The method according to claim 1, wherein the reference markings are added on the component by means of one of the following methods:
embossing,
spraying on,
material removal,
adhesive bonding,
soldering, and
welding.

34. The method according to claim 1, further comprising painting the surface of the component after levelling the unevennesses.

35. The method according to claim 34, wherein the surface of the component is not processed between the levelling of the unevennesses and the subsequent painting.

36. The method according to claim 1, further comprising at least one of the following additional steps between the levelling of the unevennesses and the subsequent painting of the surface:
grinding the surface, and
irradiation of the surface with a material processing laser for material removal.

37. The method according to claim 1, wherein the component is one of the following components:
a ship,
a rotor blade of a wind power installation,
an aeroplane component, and
a vehicle.

38. A device for carrying out the method according to claim 1.
